(19) United States
(12) Patent Application Publication
(10) Pub. No.: US 2026/0329570 A1
(43) Pub. Date: Oct. 22, 2026

(54) INTELLIGENT AND PERSONALIZED UPDATE OF A SUBJECT VEHICLE BASED ON MULTIDIMENSIONAL DATA

(71) Applicant: International Business Machines Corporation, Armonk, NY (US)

(72) Inventors: Jia Liu, BEIJING (CN); Jing Yan Zhang, BEIJING (CN); Zhan Peng Huo, BEIJING (CN); Peng Hui Jiang, BEIJING (CN)

(73) Assignee: International Business Machines Corporation, Armonk, NY (US)

(21) Appl. No.: 19/181,674

(22) Filed: Apr. 17, 2025

(51) Int. Cl. G06F 8/65; G06N 5/04

(52) U.S. Cl. CPC G06F 8/65; G06N 5/04

(57) ABSTRACT

An embodiment includes establishing, by an inference component of a subject vehicle update system, an inference model based at least in part on sensor data received from a network, where the inference model comprises multidimensional data representative of contextual relationships among a plurality of properties of a subject vehicle and a plurality of properties of a user. The embodiment includes generating, by executing a first specially purposed code within the inference component of the subject vehicle update system, a suitability metric for an update, where the suitability metric comprises a score and a suitable condition for the update of the subject vehicle. The embodiment also includes updating, by executing a second specially purposed code within a communication component of the subject vehicle update system, where the subject vehicle is updated with the update over the network according to a ranking of the suitability metric.

### BACKGROUND

The present invention relates generally to machine learning. More particularly, the present invention relates to a method, system, and computer program for Intelligent and Personalized Update of a Subject Vehicle Based on Multidimensional Data.

Advances in artificial intelligence (AI), machine learning models such as large language models (LLMs), have stunned the world with their ability to carry on open-ended conversations and solve complex tasks. LLMs are advanced artificial intelligence systems designed to understand, interpret, and generate human-like text. They are a type of deep learning model that have been trained on a wide variety of texts to understand how characters, words, and sentences function together. Deep learning involves the probabilistic analysis of unstructured data, which eventually enables the deep learning model to recognize distinctions between pieces of content without human intervention.

The global car ownership has exceeded 14 billion, of which software-defined vehicles (SDV) sales are increasing year by year. A SDV is a vehicle whose characteristics and capabilities are predominantly controlled and managed through software. This enables continuous updates, customization, and seamless integration of emerging technologies throughout its operational lifespan. Over-the-Air update or (OTA) update refers to updating vehicle software, usually by reprogramming nonvolatile memory or “flash” chips inside various subsystems. In years past, only dealers were able to update software during service appointments. Using hard-wired connections and often specialty hardware, dealers could query and then update software, either to restore damaged software, install bug fixes, or in some cases install new software versions.

### SUMMARY

The illustrative embodiments provide for Intelligent and Personalized Update of a Subject Vehicle Based on Multidimensional Data. An embodiment includes establishing, by an inference component of a subject vehicle update system, an inference model based at least in part on sensor data received from a network, where the inference model comprises multidimensional data representative of contextual relationships among a plurality of properties of a subject vehicle and a plurality of properties of a user. The embodiment includes generating, by executing a first specially purposed code within the inference component of the subject vehicle update system, a suitability metric for an update, where the suitability metric comprises a score and a suitable condition for the update of the subject vehicle. The embodiment also includes updating, by executing a second specially purposed code within a communication component of the subject vehicle update system, where the subject vehicle is updated with the update over the network according to a ranking of the suitability metric.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a system diagram of an intelligent and personalized over the air update in an environment in accordance with an illustrative embodiment;

FIG. 3 depicts a diagram of contextual relationships between the subject vehicle and the user in accordance with an illustrative embodiment;

FIG. 4 depicts a diagram of weights and dimensions of the multidimensional data in accordance with an illustrative embodiment;

FIG. 5 depicts a diagram of a decision tree for determining whether to update a subject vehicle in accordance with an illustrative embodiment;

FIG. 6 depicts a diagram of an interaction to update a subject vehicle in accordance with an illustrative embodiment; and

FIG. 7 depicts a flowchart of an intelligent and personalized update of a subject vehicle based on multidimensional data in accordance with an illustrative embodiment.

### DETAILED DESCRIPTION

With the increasing prevalence of software-defined vehicles, where over-the-air (OTA) updates once served to reduce recall costs, they now act as a game-changer for automotive industry. Today, OTA updates offer a lot of benefits including better customer experience, new business models with software differentiation, faster innovation and greater competitive potential and traditional recall cost reductions. In terms of OTA strategy, current approaches focus on which applications should be pushed to which cars and how the application update package should be deployed; however, few address the notification and timing of the OTA update. In general, when an application requires an upgrade, OEMs will send it to the automobile as soon as possible.

However, as automakers deploy OTA updates across a wide range of vehicle models, they face unique challenges in managing software complexity across all models. Vehicle and consumer safety is the top priority for a manufacturer. Ensuring the safe application and usage of OTA updates is the first challenges OEMs must overcome. However, the vehicle is not like a cell phone or a computer, its primary function is to drive and ensure driving safety. As a result, to disturb the driver as little as possible, not all OTA updates must be instantly communicated to the driver. With the increased potential for error with OTA update due to its growing prevalence, many current OTA systems fail to account for influencing factors.

Currently there is no way to ensure that an OTA update is sent to a subject vehicle at the appropriate opportunity, which can protect driving safety and improve the success rate of upgrading. There is also currently no holistic system that considers people, systems, contexts, ecosystems, grids and so on, and provides a representation model. These current limitations make it impossible to provide efficient, cost-effective and self-aware services, to end users. As a result, current efforts in this regard are inefficient and ineffective due to the current inability to determine influencing factors for an OTA update.

The present disclosure addresses the deficiencies described above by providing a process (as well as a system, method, machine-readable medium, etc.) that establishes an inference component of a subject vehicle update system that considers an inference model, a knowledge base such as properties of subject vehicles, users, behaviors, and their relationships and leverages recent advances in machine learning to determine suitability and suitable conditions for an update to a subject vehicle.

The illustrative embodiments provide for Intelligent and Personalized Update of a Subject Vehicle Based on Multidimensional Data. As used herein, the term “subject vehicle” may refer to a software-defined vehicle whose characteristics and capabilities are predominantly controlled and managed through software and/or firmware. The term “update” as used herein may refer to a firmware or software update of the subject vehicle. As used herein, the term “intelligent” may refer to adaptive and/or automated techniques, and the term “personalized” may refer to these techniques using contextual data of the subject vehicle, the user and the relationships to enable an update. As used herein, the term “multidimensional” refers to properties, relationships and contexts of data representative of a subject vehicle and a user.

As used herein, the term “machine learning model” may refer to any computer model that can be used to facilitate one or more machine learning tasks, wherein the computer model can simulate a number of interconnected processing units that can resemble abstract versions of neurons. For example, the processing units can be arranged in a plurality of layers (e.g., one or more input layers, one or more hidden layers, and/or one or more output layers) connected with by varying connection strengths (e.g., which can be commonly referred to within the art as “weights”). Machine learning models can learn through training, where data with known outcomes is inputted into the computer model, outputs regarding the data are compared to the known outcomes, and/or the weights of the computer model are autonomously adjusted based on the comparison to replicate the known outcomes.

Illustrative embodiments include establishing, by an inference component of a subject vehicle update system, an inference model based at least in part on sensor data received from a network, where the inference model comprises multidimensional data representative of contextual relationships among a plurality of properties of a subject vehicle and a plurality of properties of a user.

As used herein, the term “inference model” may refer to a machine learning model that applies logical rules to a knowledge base to evaluate and analyze new information.

Illustrative embodiments include generating, by executing a first specially purposed code within the inference component of the subject vehicle update system, a suitability metric for an update, wherein the suitability metric comprises a score and a suitable condition for the update of the subject vehicle. In some embodiments, the inference model comprises a knowledge base organized based on the multidimensional data.

As used herein, the term “inference model” may refer to determining fulfillment of a rule.

Illustrative embodiments include updating, by executing a second specially purposed code within a communication component of the subject vehicle update system, wherein the subject vehicle is updated with the update over the network according to a ranking of the suitability metric. In some embodiments, further comprising queuing the update in a queue where the update is ranked in the queue according to a rule wherein satisfying the rule is based in part on the suitable condition for the update to the subject vehicle.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

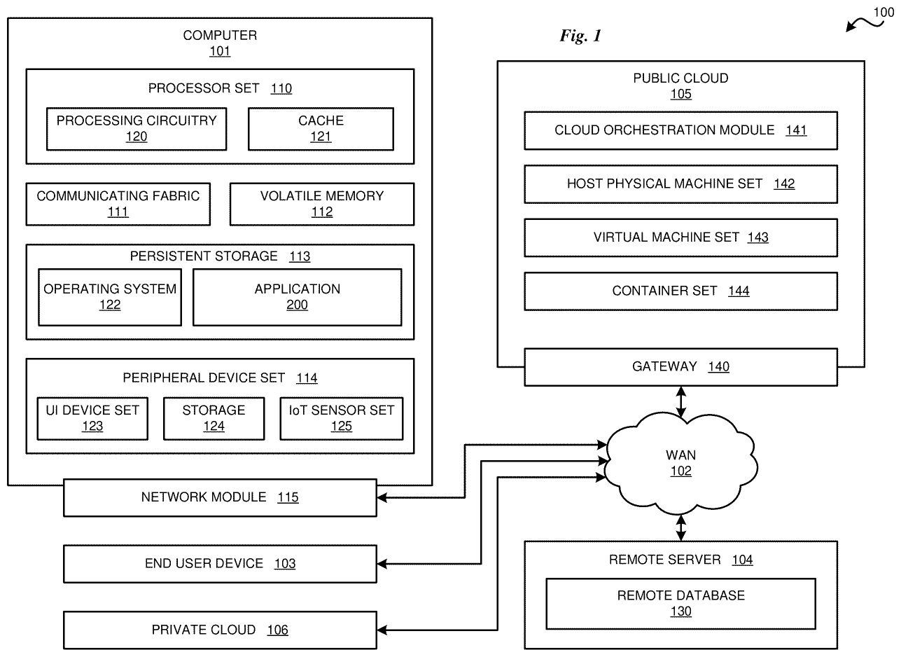

With reference to FIG. 1, this figure depicts a block diagram of a computing environment 100. Data center environment 100 contains an example of an environment for the execution of at least some of the computer code involved in performing the inventive methods, such as an Application 200 that provides Intelligent and Personalized Update of a Subject Vehicle Based on Multidimensional Data. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

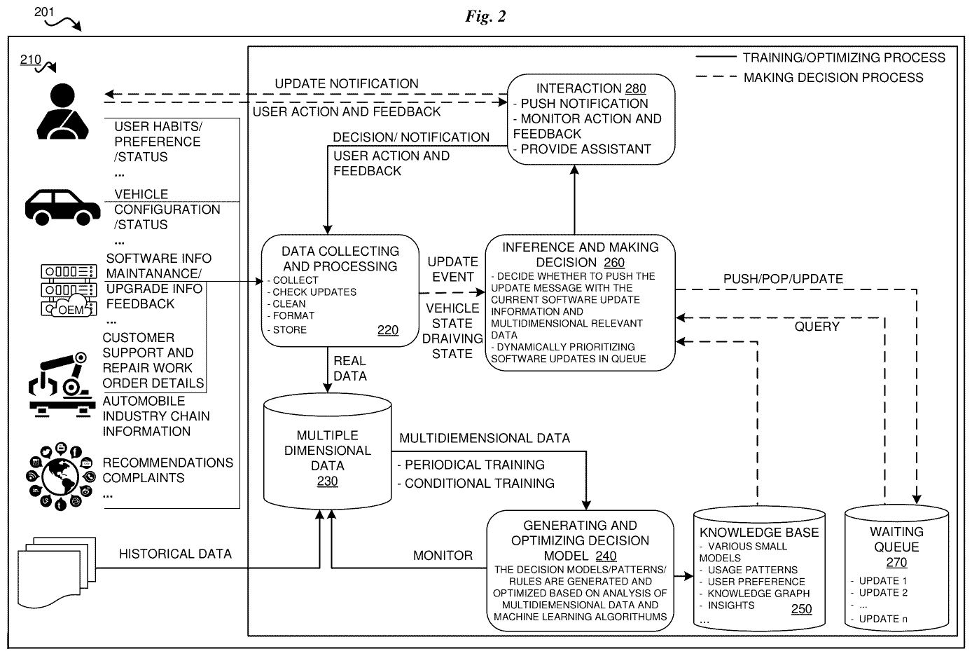

FIG. 2 depicts a system diagram of an intelligent and personalized over the air update in an environment in accordance with an illustrative embodiment. In a particular embodiment, the components of diagram 201 show aspects of the Application 200 of FIG. 1.

In the illustrated embodiment, data received from a network 210 by a subject vehicle update system comprises sensor data, user profile, vehicle data, software data and recommendation data. The data is collected and processed 220 to derive multidimensional data 230. An inference component of subject vehicle update system 160 may comprise an inference model, a generating and optimizing decision model 240 and a knowledge base 250.

In embodiments, data is collected and processed 220 by an inference component to ensure the multidimensional data (vehicle/user/software, static or dynamically) is ready for analysis and decision. Comprehensive data received from sensors or data sources include but are not limited to user habits/preference/state, vehicle configuration/state/installed software, available software info, historical pushed notifications and corresponding actions and store the structured data into a multi-dimensional data store. The sensors may include, as non-limiting examples, current sensors, voltage sensors, temperature sensors, vibration sensors, oil level sensors, and humidity sensors. Data may be received through a variety of channels including vehicle-mounted system, software vendor, original equipment manufacturer (OEM) channels, and social media. The data may be transformed, including but not limited to, a binary format from sensors, to a standard format, such as JavaScript Object Notation (JSON) or Extensible Markup Language (XML).

The subject vehicle update system may comprise a communication component that interfaces with a network adaptor, a socket, a graphics card, one or more routers, switches, hubs, and/or other network connectivity devices. The communication component may transmit and/or receive data via network links such as data may be transmitted and/or received using Wireless Application Protocol (WAP), Multimedia Messaging Service (MMS), Enhanced Messaging Service (EMS), Short Message Service (SMS), fifth generation (5G), Long Term Evolution (LTE), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

Multidimensional data may be stored in a data store in categories such as user data, vehicle data, software data, customer support and repair work order details, automobile industry supply chain information, decisions (e.g. recommended time/location/condition, priority, user action, feedback . . . ), historical data, and social network information.

A physical data storage device is the underlying technology behind a data store. The data store may comprise a data store interface that receives a provision instruction, its execution causing the data store to provision resources such as a start node queue, an end node queue, files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

The inference component 260 is closely aligned with actual condition and user preference and is capable of self-learning and continuous optimization. It may generate, by executing a first specially purposed code on a decision-making model based on decision tree and a large quantity of historical multidimensional data, a suitability metric for an update, wherein the suitability metric comprises a score and a suitable condition for the update of the subject vehicle. For example, the first specially purposed code may extract feature vectors from the multidimensional data and supplement with weighted values. The first specially purposed code may generate readable rules and decision tree models by inference algorithm. Additionally, the first specially purposed code may also determine whether to push the update message with the current software update information and multidimensional relevant data and/or dynamically prioritizing software updates in queue.

AI Inference is achieved through an “inference engine” that applies logical rules to the knowledge base to evaluate and analyze new information. In the process of machine learning, there are two phases. First, is the training phase where the model is trained by recording, storing, and labeling information. If, for example, the model is trained to identify cars, the machine-learning algorithm is fed with many images of different cars the machine can later refer to. Second, is the inference phase where the machine uses the intelligence gathered and stored in phase one to understand new data. In this phase, the machine can use inference to identify and categorize new images as “cars” despite having never seen them before. In more complex scenarios, this inference learning can be used to augment human decision making.

In some embodiments, the inference model comprises a knowledge base 250 organized based on the multidimensional data. The knowledge base includes a plurality of nodes representative of entities of the subject vehicle and the user and includes a plurality of edges connecting pairs of nodes representative of contextual relationships between the subject vehicle and the user. In some embodiments, inputs to the knowledge base include a features vector of the entity to model, the features of its edges, the contextual relationship between the subject vehicle and the user, and user behaviors. In some embodiments, the knowledge base includes small models, and recommendations.

In embodiments, the inference model within the inference component 260 may be trained using known machine learning algorithms such as k-nearest neighbors (KNN), k-means clustering, Bayesian methods, random forest and similar algorithms. In some embodiments, the inference component 260 may be re-trained or optimized based on user action and/or feedback, and/or a change to the multidimensional data. For example, a user or users may give feedback that a particular weighing of a property of subject vehicle requires adjustment or that a contextual relationship among a plurality of properties of a subject vehicle and a plurality of properties of a user requires adjustment.

In embodiments, the inference model within the inference component 260 may generate a suitability metric for an update, wherein the suitability metric comprises a score and a suitable condition for the update to the subject vehicle. For example, the suitability metric further comprises a weighing of user preferences, time and a location of the subject vehicle. The update may be queued in a queue 270 wherein the update is ranked in the queue according to a weight and a severity measure.

The inference component 260 may interface with an interaction component that communicates over a network with a user in the subject vehicle. The interaction component 280 may push notifications, monitor action & feedback, and provide a channel for interaction between a subject vehicle, a user and the system.

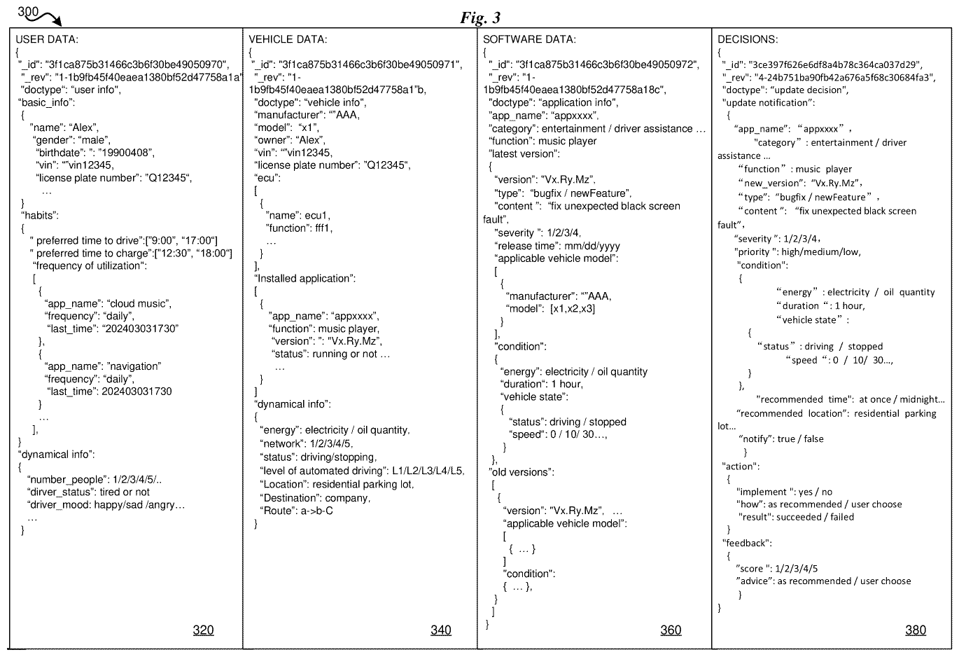

FIG. 3 depicts a diagram of contextual relationships between the subject vehicle and the user in accordance with an illustrative embodiment. In a particular embodiment, the components of diagram 300 show aspects of the Application 200 of FIG. 1.

In the illustrated embodiment, the components of diagram 300 show multidimensional data comprising data structures such as contextual user data 320 which may include but is not limited to a user profile, driving habits including typical driving times, locations, and frequencies, preference, user feedback, and mood. Another example may include social contextual data including discussions, recommendations, complaints, experiences, etc. on maintenance and upgrades on social media.

A contextual vehicle data 340 may comprise model, configuration, installed software, status, location, environmental condition, updatable software info, vehicle health status including engine performance, battery levels, and diagnostic codes to determine how software updates should be prioritized. A contextual vehicle data 340 may comprise model, configuration, installed software, status, location, environmental condition, updatable software info, vehicle health status including engine performance, battery levels, and diagnostic codes to determine how software updates should be prioritized. A contextual vehicle data 360 may comprise updatable software information, version, provider and contextual information. A contextual decisions data 380 may comprise contextual decisions made in determining an update of an application including application properties, severity, and user feedback.

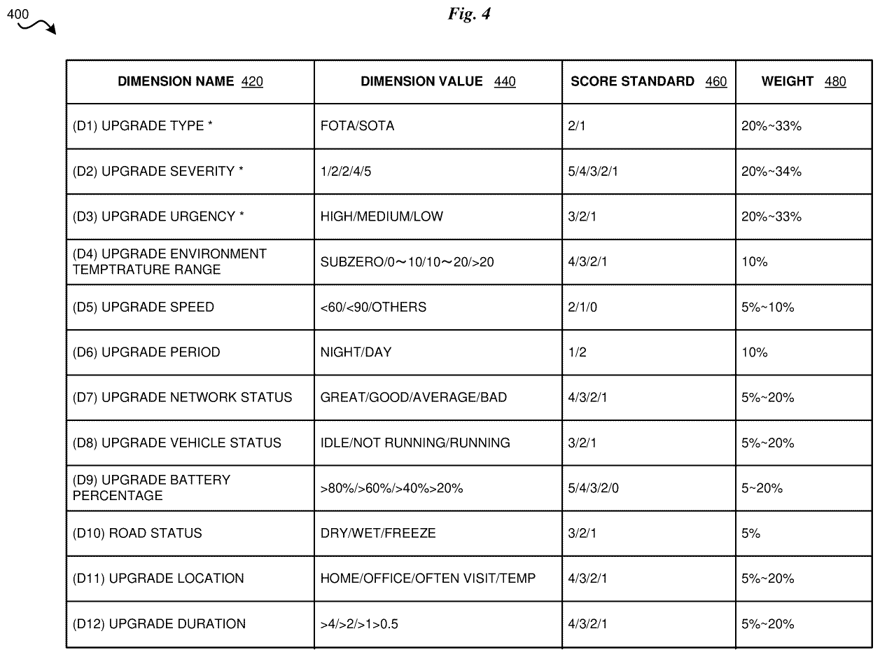

FIG. 4 depicts a diagram of weights and dimensions of the multidimensional data in accordance with an illustrative embodiment. In a particular embodiment, the components of diagram 400 show aspects of the Application 200 of FIG. 1.

In the illustrated embodiment, a dimension name 420 is related to a dimension value 440, a score standard 460, and weight 480. A dimension name 420 comprises the properties of a subject vehicle, a user and contextual data of the subject vehicle and the user such as mood, weather, and geography. For example, a dimension may be an update type, and the dimension value either firmware over-the-air (FOTA) or software-over-the-air (SOTA). A score standard 460, for instance, 1 or 2, describes the score value of a dimension. The weight 480 describes the percentage weight of the dimension to be used, for instance in the determination of a suitability metric. In some examples, a weight may be determined by known methodology, such as, Analytic Hierarchy Process (AHP). In embodiments, different dimensions, such as a property, may have different upgrade group score standard. For example, a specific dimension may be determined to have a higher score standard, it will be classified to “immediately push notification” group. In embodiments, the inference model determines a suitability metric for an update to the subject vehicle using the multidimensional data.

In embodiments, the inference component of a subject vehicle update system may execute a first specially purposed code a rule to determine whether a subject vehicle should be updated with an update. For example, with reference to diagram 400, where S is the suitability metric:

| Method | Rule | | Action |
|---|---|---|---|
| Force | 1. | “S” >= 3 AND | If rule 1 is met, immediately |
| | | (D1) == FOTA. | push notification. |
| | 2. | If (D1) == FOTA => | If rules #2 or #3 exists, |
| | | (D8) must get score | queue upgrade will go ahead |
| | | “3”, and (D9) must | when there is a suitable |
| | | higher than score “4”. | condition. |
| | 3. | If (D1) == FOTA and | If no limitation, system do |
| | | (D12) > 4 => (D6) | upgrade and notice users. |
| | | must be night, and | |
| | | (D7)'s score must | |
| | | bigger than “2”, and | |
| | | (D8) must get score | |
| | | “3”, and (D9) must | |
| | | higher than score “4”, | |
| | | and (D11) must not at | |
| | | a temporary location. | |
| customize | 1. | “S” > = 1 & “S” < 3 | Queue update |
| customize | 1. | “S” < 1 | Ignore |

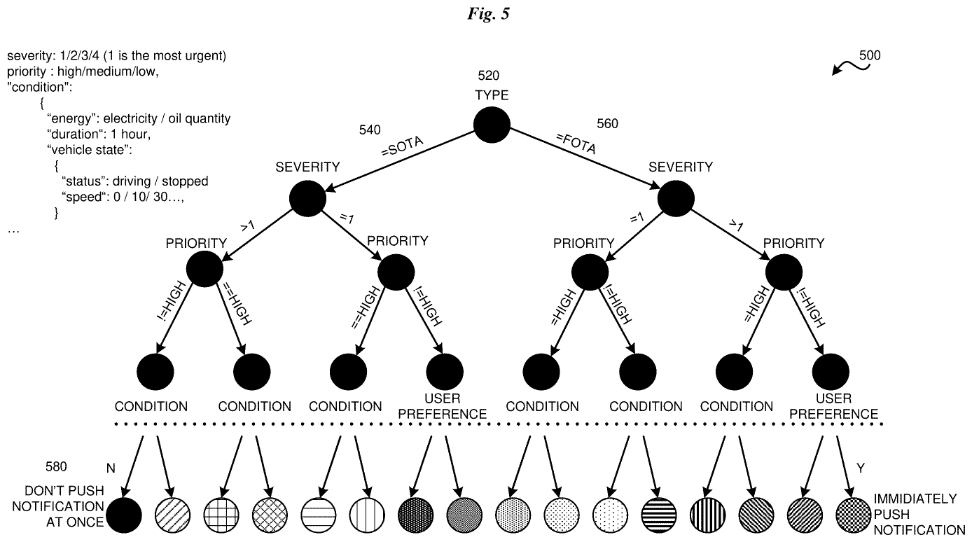

FIG. 5 depicts a diagram of a decision tree for determining whether to update a subject vehicle in accordance with an illustrative embodiment. In a particular embodiment, the components of diagram 500 show aspects of the Application 200 of FIG. 1.

In the illustrated embodiment, a type of update 520 is determined, e.g. SOTA (540) or FOTA (560). For instance, the severity of the FOTA update is then determined. If the severity, such as the score value, is greater than 1, the priority is high, and a suitable condition exists, the suitability metric is determined. In this example, although the priority is not high, the user preference is to proceed with the update resulting in an immediate update. In another example, if the type of update is SOTA, the severity is greater than 1, and the priority is low, and the suitable condition is not fulfilled. This results in a notification for an update to be queued and not sent immediately 580. In some cases, FOTA updates compared to SOTA updates will result in a score value and thus a suitability value that prioritizes the FOTA update.

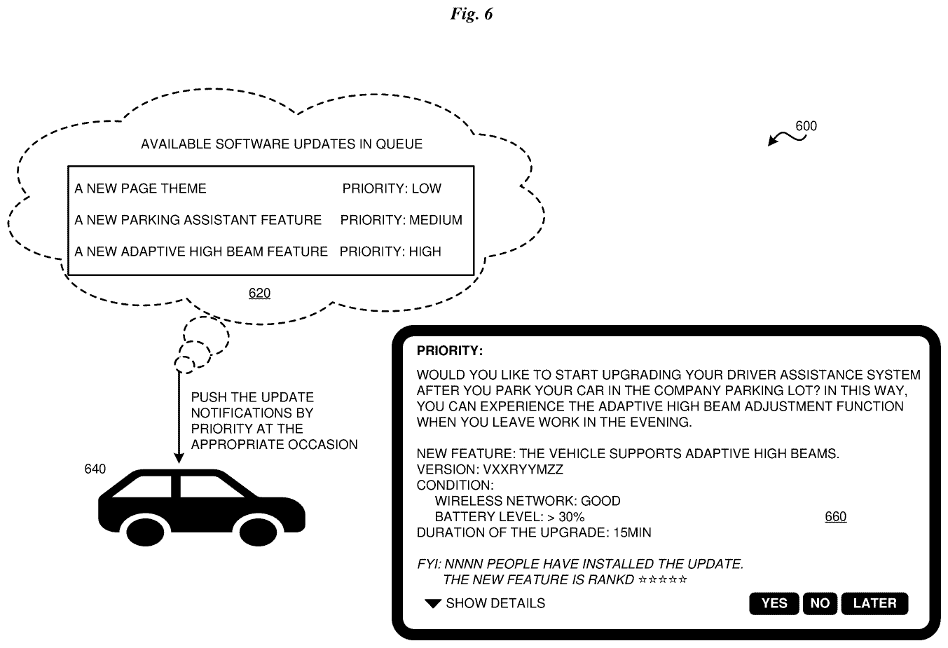

FIG. 6 depicts a diagram of an interaction to update a subject vehicle in accordance with an illustrative embodiment. In a particular embodiment, the components of diagram 600 show aspects of the Application 200 of FIG. 1.

In the illustrated embodiment, a queue 620 comprises available software updates in queue such as a new adaptive high beams feature with high priority. An update is pushed to a subject vehicle 640 when, for example, according to a ranking of the suitability metric, a weighing of user preferences, time and a location of the subject vehicle, and/or when a suitable condition set by a rule is fulfilled.

In some examples, a communication component of the subject vehicle update system executes a second specially purposed code establishing a communication channel with a subject vehicle, invoking a graphical user interface on the subject vehicle, generating text message, and sending instructions to display a notification 660 with feedback options for the user of the subject vehicle.

The notification, for example, may executing second specially purposed code to generate by a large language model (LLM) to predict and generate human-like text sequences, leveraging techniques like autoregressive generation and sampling strategies to produce coherent and contextually relevant outputs based on an input including but not limited to a suitability metric, a suitable condition, and the update type. The notification may also be configured as a Hypertext Markup Language (HTML) page with buttons to enable the user to accept, reject or save for later a suggested update. In another example, a system may override the queue and immediately update the subject vehicle, for instance, if the update type is FOTA, and the suitability metric is above a threshold as defined by a rule.

In embodiments, user feedback is sent from the subject vehicle causing an optimization instruction to be sent to an optimization interface of the inference component, execution of the optimization instruction optimizing the inference model and/or the knowledge base. For example, the inference model may be re-trained or optimized based on feature vectors, weights and scores that are modified as a result of user action and/or feedback, and/or a change to the multidimensional data.

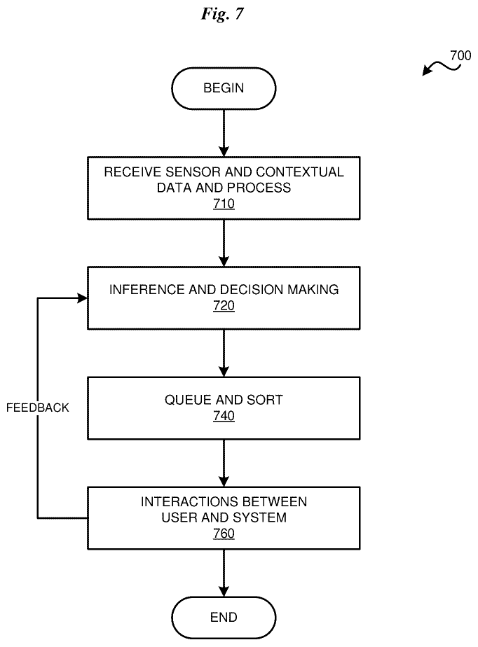

FIG. 7 depicts a flowchart of an intelligent and personalized update of a subject vehicle based on multidimensional data in accordance with an illustrative embodiment. In a particular embodiment, the components of diagram 700 show aspects of the Application 200 of FIG. 1.

In the illustrated embodiment, a subject vehicle update system receives sensor and contextual data relating to a subject vehicle and performs processing at step 710. For example, the subject vehicle update system establishes a cellular network connection with a subject vehicle to retrieve vehicle configuration data. The subject vehicle update system may also establish an internet connection with a vehicle manufacturer to retrieve update information. In another example, user preference data may be retrieved from a secure data store. The retrieved information is transformed into multidimensional data representative of contextual relationships among a plurality of properties of a subject vehicle and a plurality of properties of a user. In embodiments, the inference model comprises a knowledge base organized based on the multidimensional data. The knowledge base includes a plurality of nodes representative of entities of the subject vehicle and the user and includes a plurality of edges connecting pairs of nodes representative of contextual relationships between the subject vehicle and the user. In some embodiments, inputs to the knowledge base include a features vector of the entity to model, the features of its edges, the contextual relationship between the subject vehicle and the user, and user behaviors.

At step 720, the system performs inference and decision making by executing a first specially purposed code within the inference component of the subject vehicle update system. In some examples, the inference component 260 may generate a suitability metric for an update, wherein the suitability metric comprises a score and a suitable condition for the update to the subject vehicle. For example, the suitability metric further comprises a weighing of user preferences, time and a location of the subject vehicle.

At step 740, the system queues and sorts the updates. For instance, queuing the update in a queue wherein the update is ranked in the queue according to a rule where satisfying the rule is based in part on the suitable condition for the update to the subject vehicle. In some examples, the updates in the queue are sorted or ranked according to a ranking of the suitability metric, a weighing of user preferences, time and a location of the subject vehicle and/or a suitable condition based on a rule.

At step 760, the system enables interactions between the user of the subject vehicle and the system. An update is pushed to a subject vehicle from the queue when, for example, according to a ranking of the suitability metric, a weighing of user preferences, time and a location of the subject vehicle, and/or when a suitable condition set by a rule is fulfilled. A communication component of the subject vehicle update system executes a second specially purposed code to establish a communication channel with a subject vehicle and a notification is displayed on a display of the subject vehicle feedback options for the user of the subject vehicle. The notification, for example, may be configured as a Hypertext Markup Language (HTML) page with buttons to enable the user to accept, reject or save for later a suggested update. In another example, a system may override the queue and immediately update the subject vehicle, for instance, if the update type is FOTA, and the suitability metric is above a threshold as defined by a rule.

In embodiments, user feedback is sent from the subject vehicle causing an optimization instruction to be sent to an optimization interface of the inference component, execution of the optimization instruction optimizing the inference model. For example, the inference model may be re-trained or optimized based on feature vectors, weights and scores that are modified as a result of user action and/or feedback, and/or a change to the multidimensional data.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing, by an inference component of a subject vehicle update system, an inference model based at least in part on sensor data received from a network, wherein the inference model comprises multidimensional data representative of contextual relationships among a plurality of properties of a subject vehicle and a plurality of properties of a user;
generating, by executing a first specially purposed code within the inference component of the subject vehicle update system, a suitability metric for an update, wherein the suitability metric comprises a score and a suitable condition for the update of the subject vehicle; and
updating, by executing a second specially purposed code within a communication component of the subject vehicle update system, wherein the subject vehicle is updated with the update over the network according to a ranking of the suitability metric.

2. The computer-implemented method of claim 1, wherein the suitability metric further comprises a weighing of user preferences and operating environment of the subject vehicle.

3. The computer-implemented method of claim 1, wherein the inference model comprises a knowledge base organized based on the multidimensional data.

4. The computer-implemented method of claim 1, further comprising queuing the update in a queue wherein the update is ranked in the queue according to a rule wherein satisfying the rule is based in part on the suitable condition for the update to the subject vehicle.

5. The computer-implemented method of claim 1, comprising transmitting a notification to the subject vehicle based on a profile of the user of the subject vehicle.

6. The computer-implemented method of claim 1, wherein user feedback is sent from the subject vehicle causing an optimization instruction to be sent to an optimization interface of the inference model, execution of the optimization instruction optimizing the inference model.

7. The computer-implemented method of claim 1, wherein the multidimensional data comprises a user profile, vehicle data, software data and recommendation data.

8. A computer program product comprising one or more computer readable storage media, and program instructions collectively stored on the one or more computer readable storage media, the program instructions executable by a processor to cause the processor to perform operations comprising:
establishing, by an inference component of a subject vehicle update system, an inference model based at least in part on sensor data received from a network, wherein the inference model comprises multidimensional data representative of contextual relationships among a plurality of properties of a subject vehicle and a plurality of properties of a user;
generating, by executing a first specially purposed code within the inference component of the subject vehicle update system, a suitability metric for an update, wherein the suitability metric comprises a score and a suitable condition for the update of the subject vehicle; and
updating, by executing a second specially purposed code within a communication component of the subject vehicle update system, wherein the subject vehicle is updated with the update over the network according to a ranking of the suitability metric.

9. The computer program product of claim 8, wherein the suitability metric further comprises a weighing of user preferences and operating environment of the subject vehicle.

10. The computer program product of claim 8, wherein the inference model comprises a knowledge base organized based on the multidimensional data.

11. The computer program product of claim 8, further comprising queuing the update in a queue wherein the update is ranked in the queue according to a rule wherein satisfying the rule is based in part on the suitable condition for the update to the subject vehicle.

12. The computer program product of claim 8, comprising transmitting a notification to the subject vehicle based on a profile of the user of the subject vehicle.

13. The computer program product of claim 8, wherein user feedback is sent from the subject vehicle causing an optimization instruction to be sent to an optimization interface of the inference model, execution of the optimization instruction optimizing the inference model.

14. The computer program product of claim 8, wherein the multidimensional data comprises a user profile, vehicle data, software data and recommendation data.

15. A computer system comprising a processor and one or more computer readable storage media, and program instructions collectively stored on the one or more computer readable storage media, the program instructions executable by the processor to cause the processor to perform operations comprising:
establishing, by an inference component of a subject vehicle update system, an inference model based at least in part on sensor data received from a network, wherein the inference model comprises multidimensional data representative of contextual relationships among a plurality of properties of a subject vehicle and a plurality of properties of a user;
generating, by executing a first specially purposed code within the inference component of the subject vehicle update system, a suitability metric for an update, wherein the suitability metric comprises a score and a suitable condition for the update of the subject vehicle; and
updating, by executing a second specially purposed code within a communication component of the subject vehicle update system, wherein the subject vehicle is updated with the update over the network according to a ranking of the suitability metric.

16. The computer system of claim 15, wherein the suitability metric further comprises a weighing of user preferences and operating environment of the subject vehicle.

17. The computer system of claim 15, wherein the inference model comprises a knowledge base organized based on the multidimensional data.

18. The computer system of claim 15, further comprising queuing the update in a queue wherein the update is ranked in the queue according to a rule wherein satisfying the rule is based in part on the suitable condition for the update to the subject vehicle.

19. The computer system of claim 15, comprising transmitting a notification to the subject vehicle based on a profile of the user of the subject vehicle.

20. The computer system of claim 15, wherein user feedback is sent from the subject vehicle causing an optimization instruction to be sent to an optimization interface of the inference model, execution of the optimization instruction optimizing the inference model.
